(19) United States
(12) Patent Application Publication
(10) Pub. No.: US 2008/0074353 A1
(43) Pub. Date: Mar. 27, 2008

(54) PLASMA DISPLAY APPARATUS AND TELEVISION SET INCLUDING THE SAME

(76) Inventor: Jongwoon BAE, Gumi-city (KR)

Correspondence Address: KED & ASSOCIATES, LLP, P.O. Box 221200, Chantilly, VA, 20153-1200, US

(21) Appl. No.: 11/858,685

(22) Filed: Sep. 20, 2007

(30) Foreign Application Priority Data
Sep. 21, 2006 (KR) 10-2006-0091622

(51) Int. Cl. G09G 3/28

(52) U.S. Cl. 345/60

(57) ABSTRACT

A plasma display apparatus and a television set including the same are disclosed. The plasma display apparatus includes a plasma display panel, a filter and a driver. The filter is positioned in front of the plasma display panel, and includes a mesh type electromagnetic interference (EMI) shielding layer. A near infrared ray shielding layer is omitted from the filter. The driver drives the plasma display panel using a control signal having a wavelength of 1 cm to 1 m received from the outside.

This application claims the benefit of Korean Patent Application No. 10-2006-0091622 filed on Sep. 21, 2006, which is hereby incorporated by reference.

### BACKGROUND OF THE DISCLOSURE

1. Field of the Disclosure

This document relates to a plasma display apparatus and a television set including the same.

2. Description of the Background Art

A plasma display apparatus includes a plasma display panel displaying an image.

The plasma display panel includes a phosphor layer inside discharge cells partitioned by barrier ribs and a plurality of electrodes. A driving signal is supplied to the discharge cells through the electrodes, thereby generating a discharge inside the discharge cells.

When the driving signal generates the discharge inside the discharge cells, a discharge gas filled in the discharge cells generates vacuum ultraviolet rays, which thereby cause phosphors formed inside the discharge cells to emit light, thus displaying an image on the screen of the plasma display panel.

An operation of the plasma display panel can be controlled by a control signal received from the outside. For instance, the plasma display panel receives a control signal output from a remote controller positioned outside the plasma display panel, and is controlled in response to the received control signal.

In the related art plasma display apparatus, near infrared rays are emitted to the outside during its driving, thereby causing a malfunction of another device such as a remote controller.

### SUMMARY OF THE DISCLOSURE

In an aspect, a plasma display apparatus comprises a plasma display panel that displays an image using a control signal having a wavelength of 1 cm to 1 m received from the outside, and a filter that is positioned in front of the plasma display panel, a near infrared ray shielding layer being omitted from the filter.

In another aspect, a plasma display apparatus comprises a plasma display panel, a filter that is positioned in front of the plasma display panel and includes a mesh type electromagnetic interference (EMI) shielding layer, a near infrared ray shielding layer being omitted from the filter, and a driver that drives the plasma display panel using a control signal having a wavelength of 1 cm to 1 m received from the outside.

In still another aspect, television set comprises a demultiplexer that divides an input signal into a video signal and a voice signal, a video processing unit that processes the video signal to allow a user to watch the video signal, a plasma display panel that displays the video signal processed by the video processing unit, a filter that is positioned in front of the plasma display panel, a near infrared ray shielding layer being omitted from the filter, and a controller that receives a control signal having a wavelength of 1 cm to 1 m and controls the video signal using the control signal.

### BRIEF DESCRIPTION OF THE DRAWINGS

The accompanying drawings, which are included to provide a further understanding of the invention and are incorporated on and constitute a part of this specification, illustrate embodiments of the invention and together with the description serve to explain the principles of the invention. In the drawings:

FIG. 1 illustrates a configuration of a plasma display apparatus according an exemplary embodiment;

FIG. 2 illustrates a filter and a plasma display panel;

FIG. 3 illustrates a case where at least one of a scan electrode or a sustain electrode has a multi-layered structure;

FIG. 4 illustrates a case where at least one of a scan electrode or a sustain electrode has a single-layered structure;

FIG. 5 illustrates a wavelength of a noise generated when a plasma display panel is driven;

FIG. 6 illustrates a structure of a filter having a near infrared ray shielding layer;

FIG. 7 illustrates a scan electrode and a sustain electrode each having a single-layered structure;

FIG. 8A illustrates a scan electrode and a sustain electrode each having a multi-layered structure, and FIG. 8B illustrates a scan electrode and a sustain electrode each having a single-layered structure;

FIGS. 9A and 9B are graphs showing a luminance and a firing voltage depending on a content of Xe;

FIGS. 10A and 10B are views for explaining kinds of electromagnetic interference (EMI) shielding layer;

FIG. 11 illustrates an EMI shielding layer included in the filter of the plasma display apparatus according to the exemplary embodiment;

FIG. 12 illustrates a shielding layer of a filter;

FIG. 13 illustrates a function of a shielding layer;

FIG. 14 illustrates an example of a traveling direction of a second portion of a filter;

FIG. 15 illustrates another example of a traveling direction of a second portion;

FIG. 16 illustrates an operation of the plasma display apparatus according to the exemplary embodiment; and

FIG. 17 illustrates a television set including the plasma display apparatus according to the exemplary embodiment.

### DETAILED DESCRIPTION OF EMBODIMENTS

Reference will now be made in detail embodiments of the invention examples of which are illustrated in the accompanying drawings.

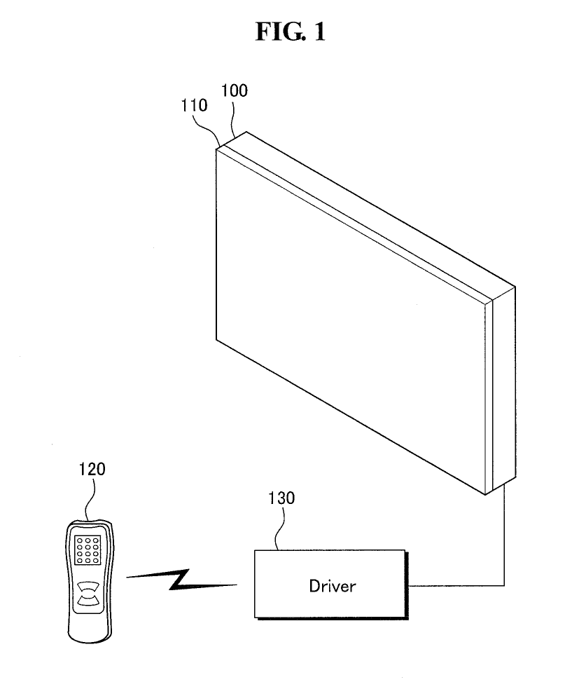

FIG. 1 illustrates a configuration of a plasma display apparatus according an exemplary embodiment.

As illustrated in FIG. 1, a plasma display apparatus according an exemplary embodiment includes a plasma display panel 100, a filter 110 and a driver 130. The plasma display apparatus according the exemplary embodiment may further include a remote controller 120 for controlling an operation of the panel 100.

The filter 110 is positioned in front of the plasma display panel 100. A near infrared ray shielding layer for absorbing or shielding near infrared rays may be omitted from the filter 110.

The remote controller 120 can send a control signal having a wavelength of 1 cm to 1 m.

The driver 130 receives the control signal having the wavelength of 1 cm to 1 m from the remote controller 120, and control an operation of the plasma display panel 100 in response to the received control signal.

The plasma display panel 100 includes an electrode, and displays an image on the screen. In other words, the remote controller 120 controls an operation of the plasma display panel 100 using the control signal having the wavelength of 1 cm to 1 m.

For instance, if a user instructs an ON-signal to the remote controller 120 in an off-state of the plasma display panel 100, the remote controller 120 generates a control signal in response to the ON-signal and sends it. The control signal has a wavelength of 1 cm to 1 m.

The driver 130 receives the control signal sent by the remote controller 120 and turns on the plasma display panel 100 in response to the received control signal.

In other words, the plasma display panel 100 operates in response to the control signal with a wavelength of 1 cm to 1 m received from the outside, thereby displaying an image on the screen.

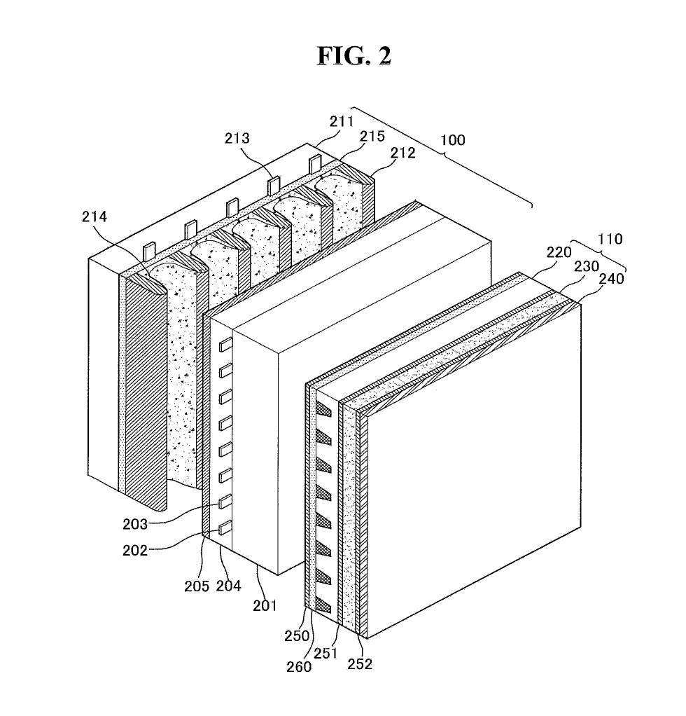

FIG. 2 illustrates a filter and a plasma display panel.

As illustrated in FIG. 2, the plasma display apparatus according the exemplary embodiment includes a plasma display panel 100 and a filter 110 positioned in front of the plasma display panel 100.

The plasma display panel includes a front substrate 201 and a rear substrate 211 which are coalesced with each other to oppose each other. On the front substrate 201, a scan electrode 202 and a sustain electrode 203 are positioned in parallel to each other. On the rear substrate 211, an address electrode 213 is positioned to intersect the scan electrode 202 and the sustain electrode 203.

An upper dielectric layer 204 for covering the scan electrode 202 and the sustain electrode 203 is positioned on the front substrate 201 on which the scan electrode 202 and the sustain electrode 203 are positioned.

The upper dielectric layer 204 limits discharge currents of the scan electrode 202 and the sustain electrode 203, and provides electrical insulation between the scan electrode 202 and the sustain electrode 203.

A protective layer 205 is positioned on the upper dielectric layer 204 to facilitate discharge conditions. The protective layer 205 may include a material having a high secondary electron emission coefficient, for example, magnesium oxide (MgO).

A lower dielectric layer 215 for covering the address electrode 213 is positioned on the rear substrate 211 on which the address electrode 213 is positioned. The lower dielectric layer 215 provides electrical insulation of the address electrode 213.

Barrier ribs 212 of a stripe type, a well type, a delta type, a honeycomb type, and the like, are positioned between the front substrate 201 and the rear substrate 211 to partition discharge spaces (i.e., discharge cells). A red (R) discharge cell, a green (G) discharge cell, and a blue (B) discharge cell, and the like, may be positioned between the front substrate 201 and the rear substrate 211.

For instance, the closed-type barrier rib 212 may include a first barrier rib (not shown) and a second barrier rib (not shown) which intersect each other. A height of the first barrier rib may be different from a height of the second barrier rib.

Each discharge cell partitioned by the barrier ribs 212 is filled with a predetermined discharge gas. Examples of the predetermined discharge gas may include neon (Ne) and xenon (Xe). A phosphor layer 214 is positioned inside the discharge cells to emit visible light for an image display during the generation of an address discharge. For instance, red (R), green (G) and blue (B) phosphor layers may be positioned inside the discharge cells.

In addition to the red (R), green (G), and blue (B) phosphor layers, a white (W) phosphor layer or a yellow (Y) phosphor layer may be further formed. Accordingly, in addition to the red (R), green (G), and blue (B) discharge cells, a white (W) discharge cell or a yellow (Y) discharge cell may be further positioned between the front substrate 201 and the rear substrate 211.

Widths of the red (R), green (G), and blue (B) discharge cells may be substantially equal to one another. Further, a width of at least one of the red (R), green (G), or blue (B) discharge cells may be different from widths of the other discharge cells.

For instance, a width of the red (R) discharge cell may be the smallest, and widths of the green (G) and blue (B) discharge cells may be larger than the width of the red (R) discharge cell. Thus, a width of the phosphor layer 214 positioned inside the discharge cell changes depending on the width of the discharge cell. For instance, a width of a blue (B) phosphor layer formed inside the blue (B) discharge cell may be larger than a width of a red (R) phosphor layer formed inside the red (R) discharge cell. Further, a width of a green (G) phosphor layer formed inside the green (G) discharge cell may be larger than the width of the red (R) phosphor layer formed inside the red (R) discharge cell. Hence, since the quantity of blue light is more than the quantity of red light, a color temperature of an image displayed on the plasma display panel can be improved.

The plasma display panel according to the exemplary embodiment can have various forms of barrier rib structures. For instance, the barrier rib 212 includes a first barrier rib (not shown) and a second barrier rib (not shown) which intersect each other. The barrier rib 212 may have a differential type barrier rib structure in which a height of the first barrier rib and a height of the second barrier rib are different from each other, a channel type barrier rib structure in which a channel usable as an exhaust path is formed on at least one of the first barrier rib or the second barrier rib, a hollow type barrier rib structure in which a hollow is formed on at least one of the first barrier rib or the second barrier rib, and the like.

While the plasma display panel according to the exemplary embodiment has been illustrated and described to have the red (R), green (G), and blue (B) discharge cells arranged on the same line, it is possible to arrange them in a different pattern. For instance, a delta type arrangement in which the red (R), green (G), and blue (B) discharge cells are arranged in a triangle shape may be applicable. Further, the discharge cells may have a variety of polygonal shapes such as pentagonal and hexagonal shapes as well as a rectangular shape.

A thickness of at least one of the phosphor layers 214 formed inside the red (R), green (G) and blue (B) discharge cells may be different from thicknesses of the other phosphor layers. For instance, thicknesses of green (G) and blue (B) phosphor layers inside the green (G) and blue (B) discharge cells may be larger than a thickness of a red (R) phosphor layer inside the red (R) discharge cell.

While the address electrode 213 formed on the rear substrate 211 may have a substantially constant width or thickness, a width or thickness of the address electrode 213 inside the discharge cell may be different from a width or thickness of the address electrode 213 outside the discharge cell. For instance, a width or thickness of the address electrode 213 inside the discharge cell may be larger than a width or thickness of the address electrode 213 outside the discharge cell.

The filter 110 includes a shielding layer 220 for shielding light coming from the outside. The filter 110 further includes a color layer 230 and an electromagnetic interference (EMI) shielding layer 240.

A first adhesive layer 251 is formed between the shielding layer 220 and the color layer 230 to attach the shielding layer 220 to the color layer 230. A second adhesive layer 252 is formed between the color layer 230 and the EMI shielding layer 240 to attach the color layer 230 to the EMI shielding layer 240.

A reference numeral 260 indicates a substrate. The substrate 260 provides a formation space of the shielding layer 220, the color layer 230 and the EMI shielding layer 240. The substrate 260 may be formed of a polymer resin or a glass.

A reference numeral 250 indicates a third adhesive layer. The third adhesive layer 250 is used to attach the filter 110 to the plasma display panel 100. In case that the substrate 260 is formed of a glass, the third adhesive layer 250 may be omitted.

Locations of the shielding layer 220, the color layer 230, the EMI shielding layer 240 and the substrate 260 may change. For instance, the EMI shielding layer 240 may be positioned on the substrate 260, the color layer 230 may be positioned on the EMI shielding layer 240, and the shielding layer 220 may be positioned on the color layer 230.

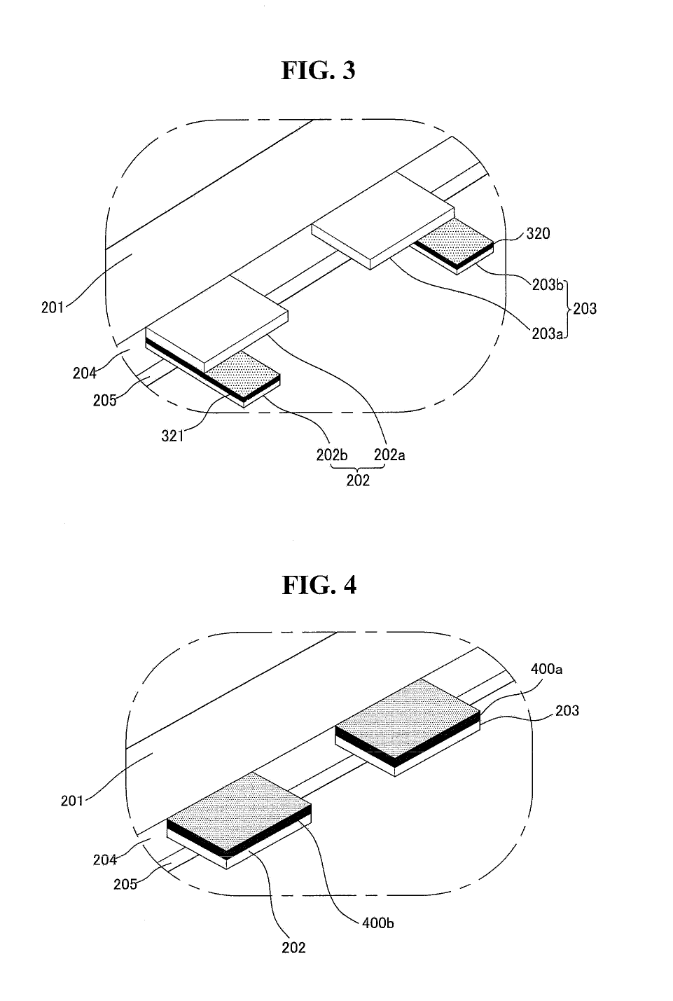

FIG. 3 illustrates a case where at least one of a scan electrode or a sustain electrode has a multi-layered structure.

As illustrated in FIG. 3, at least one of the scan electrode 202 or the sustain electrode 203 may have a multi-layered structure, for instance, a two-layered structure. For instance, the scan electrode 202 or the sustain electrode 203 each include transparent electrodes 202a and 203a and bus electrodes 202b and 203b.

The transparent electrodes 202a and 203a may include a transparent material such as indium-tin-oxide (ITO), and the bus electrodes 202b and 203b may include a metal material such as silver (Ag).

First black layers 320 and 321 may be positioned between the transparent electrodes 202a and 203a and the bus electrodes 202b and 203b.

FIG. 4 illustrates a case where at least one of a scan electrode or a sustain electrode has a single-layered structure.

As illustrated in FIG. 4, the scan electrode 202 and the sustain electrode 203 have a single-layered structure, and include only a bus electrode.

The scan electrode 202 and the sustain electrode 203 may include a substantially opaque electrically conductive metal material. For instance, the scan electrode 202 and the sustain electrode 203 may include an opaque material that has excellent electrical conductivity like Ag, Cu and Al and is cheaper than a transparent material such as ITO. Second black layers 400a and 400b may be positioned between the scan and sustain electrodes 202 and 203 and the front substrate 201.

At least one of the scan electrode 202 or the sustain electrode 203 may further include a black material such as carbon (C), cobalt (Co) or ruthenium (Ru).

In case that the scan electrode 202 and the sustain electrode 203 have the single-layered structure, a fabrication process of the single-layered structure is simpler than that of the multi-layered structure, thereby reducing the fabrication cost. Further, since the single-layered structure uses a material cheaper than the multi-layered structure, the fabrication cost is further reduced.

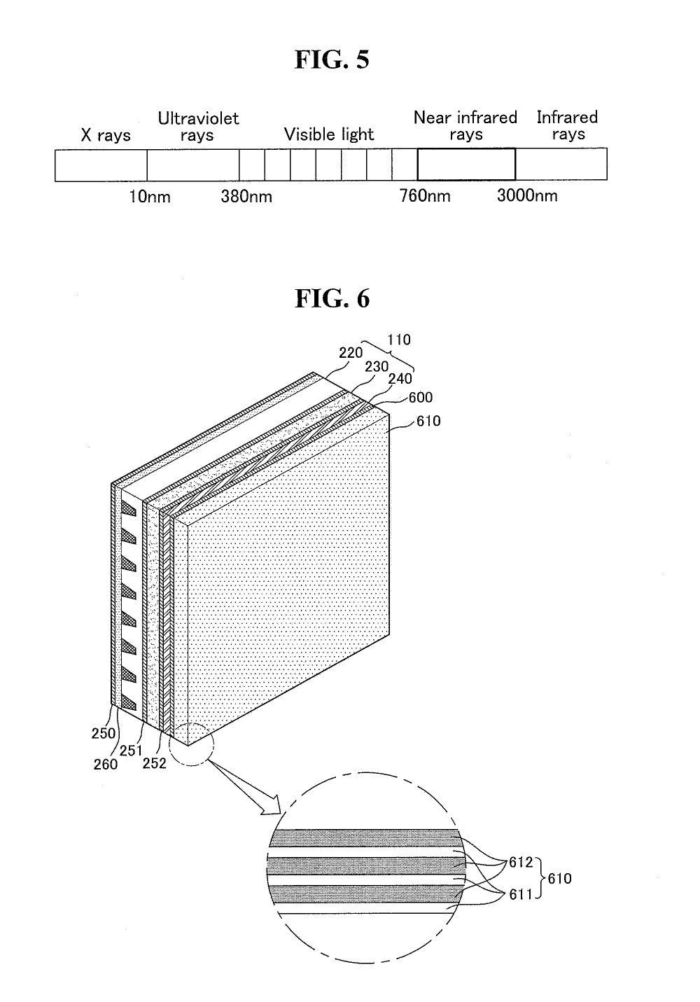

FIG. 5 illustrates a wavelength of a noise generated when a plasma display panel is driven.

FIG. 6 illustrates a structure of a filter having a near infrared ray shielding layer.

When the plasma display panel is driven, as illustrated in FIG. 5, near infrared rays having a wavelength band of about 760 to 3,000 nm between a wavelength band of visible light and a wavelength band of infrared rays is emitted. A discharge gas including Xe is filed inside the plasma display panel, and Xe increases the emission amount of near infrared rays emitted when the plasma display panel is driven.

The near infrared rays are a kind of noise, and cause a malfunction of an external device such as a remote controller.

To prevent the malfunction of the external device, a filter may include a near infrared ray shielding layer capable of absorbing or reflecting near infrared rays. For instance, as illustrated in FIG. 6, the filter 110 further includes a near infrared ray shielding layer 610. A reference numeral 600 indicates a fourth adhesive layer for attaching the near infrared ray shielding layer 610 to the filter 110.

The near infrared ray shielding layer 610 has a structure in which a transparent layer 611 for absorbing or reflecting near infrared rays and an opaque metal layer 612 are stacked in turn.

In case that the transparent layer 611 and the opaque metal layer 612 are excessively thick, light transmittance may be excessively reduced. Therefore, the transparent layer 611 may have a thickness of about 300 to 800 Å and the opaque metal layer 612 may have a thickness of about 100 to 200 Å so as to prevent an excessive reduction in the light transmittance.

The near infrared ray shielding layer 610 can shield near infrared rays emitted from the plasma display panel. However, the fabrication cost of the near infrared ray shielding layer 610 is high, thereby increasing the fabrication cost of the plasma display apparatus.

When the control signal having the wavelength of 1 cm to 1 m is used to control the operation of the plasma display panel, the plasma display panel can stably operate without the near infrared ray shielding layer regardless of the emission of near infrared rays having a wavelength of about 760 nm to 3,000 nm.

For instance, it is assumed that the remote controller sends a control signal having a wavelength of 2,000 nm less than 1 cm to the driver and the driver receives the control signal to control the operation of the plasma display panel. In this case, if the near infrared ray shielding layer is omitted from the filter, near infrared rays emitted from the plasma display panel and the control signal sent by the remote controller may be confused. Accordingly, the driver may cause a malfunction of the plasma display panel by judging the near infrared rays emitted from the plasma display panel as the control signal.

On the other hand, in case that the remote controller sends a control signal having a wavelength of 1 cm to 1 m to the driver and the driver receives the control signal to control the operation of the plasma display panel as in the exemplary embodiment, a malfunction of the plasma display panel can be prevented without the near infrared ray shielding layer because a wavelength band of the control signal is substantially different from a wavelength band of near infrared rays emitted from the plasma display panel.

Accordingly, since the control signal having the wavelength of 1 cm to 1 m is used to control the operation of the plasma display panel in the exemplary embodiment, the near infrared ray shielding layer can be omitted from the filter and thus the fabrication cost of the plasma display apparatus can be reduced.

A signal having a wavelength more than 1 cm may include a bluetooth signal or a radio frequency (RF) signal. In other words, the plasma display apparatus according to the exemplary embodiment can control the operation of the plasma display panel using a bluetooth signal or an RF signal. The control signal may having a wavelength of 0.11 m to 0.13 m.

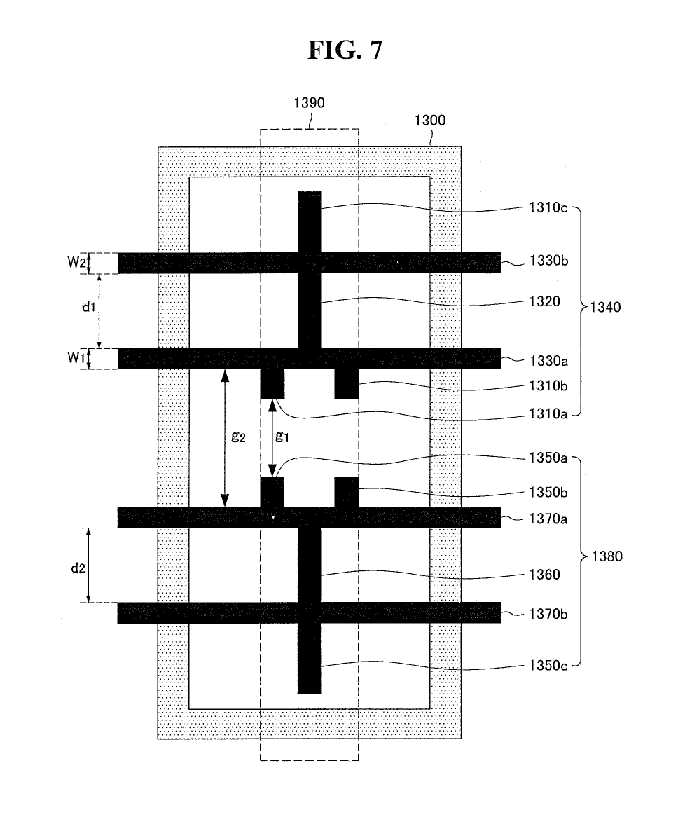

FIG. 7 illustrates a scan electrode and a sustain electrode each having a single-layered structure.

As illustrated in FIG. 7, a scan electrode 1340 and a sustain electrode 1380 each have a single-layered structure. The scan electrode 1340 may include one or more line portions 1330a and 1330b intersecting an address electrode 1390 inside a discharge cell partitioned by a barrier rib 1300, and the sustain electrode 1380 may include one or more line portions 1370a and 1370b intersecting the address electrode 1390 inside the discharge cell.

The line portions 1330a, 1330b, 1370a and 1370b are spaced apart from each other with a predetermined distance therebetween inside the discharge cell. For instance, the first and second line portions 1330a and 1330b of the scan electrode 1340 are spaced apart from each other with a distance of d1, and the first and second line portions 1370a and 1370b of the sustain electrode 1380 are spaced apart from each other with a distance of d2. A value of d1 may be equal to or different from a value of d2.

The line portions 1330a, 1330b, 1370a and 1370b each have a predetermined width. For instance, the first and second line portions 1330a and 1330b of the scan electrode 1340 have widths of W1 and W2, respectively. A value of W1 may be equal to or different from a value of W2.

A shape of the scan electrode 1340 may be symmetrical to a shape of the sustain electrode 1380.

The scan electrode 1340 may include projecting portions 1310a, 1310b and 1310c parallel to the address electrode 1390, and the sustain electrode 1380 may include projecting portions 1350a, 1350b and 1350c parallel to the address electrode 1390.

The projecting portions 1310a, 1310b, 1310c, 1350a, 1350b and 1350c are formed to project from at least one of the line portions 1330a, 1330b, 1370a and 1370b. For instance, the projecting portions 1310a and 1310b of the scan electrode 1340 projects from the first line portion 1330a, and the projecting portion 1310c of the scan electrode 1340 projects from the second line portion 1330b.

A distance g1 between a portion of the scan electrode 1340 having the projecting portions 1310a, 1310b and 1310c and a portion of the sustain electrode 1380 having the projecting portions 1350a, 1350b and 1350c is shorter than a distance g2 between a portion of the scan electrode 1340 not having a projecting portion and a portion of the sustain electrode 1380 not having a projecting portion. Hence, a firing voltage of a discharge generated between the scan electrode 1340 and the sustain electrode 1380 can be lowered.

The projecting portions 1310a, 1310b, 1310c, 1350a, 1350b and 1350c may overlap the address electrode 1390 inside the discharge cell. In this case, a firing voltage between the scan electrode 1340 and the address electrode 1390 and a firing voltage between the sustain electrode 1380 and the address electrode 1390 can be lowered.

The scan electrode 1340 may include a connecting portion 1320 for connecting the first and second line portions 1330a and 1330b. The sustain electrode 1380 may include a connecting portion 1360 for connecting the first and second line portions 1370a and 1370b. The connecting portions 1320 and 1360 can evenly diffuse a discharge into the entire discharge cell.

FIG. 7 illustrated the projecting portions 1310a, 1310b, 1310c, 1350a, 1350b and 1350c of a polygon shape. However, at least one of the projecting portions 1310a, 1310b, 1310c, 1350a, 1350b and 1350c may include a portion having curvature.

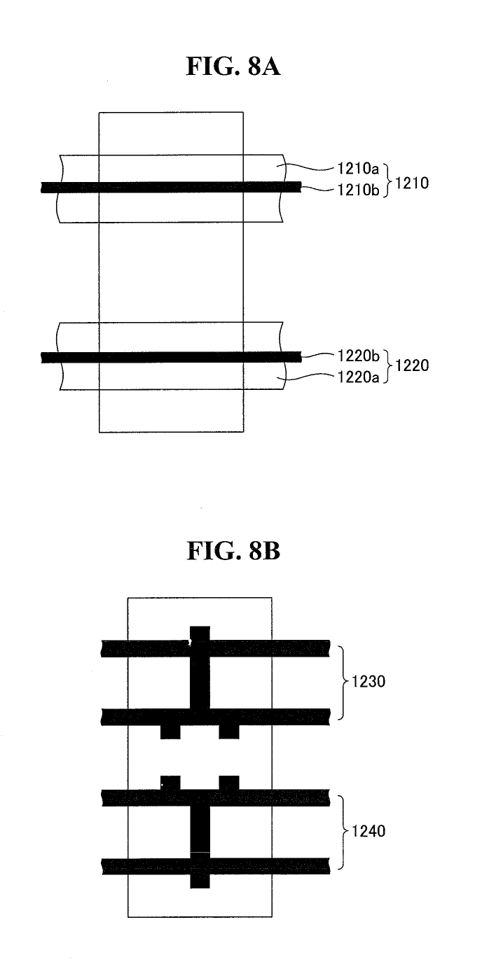

FIG. 8A illustrates a scan electrode 1210 and a sustain electrode 1220 each having a multi-layered structure in the same way as FIG. 3, and FIG. 8B illustrates a scan electrode 1230 and a sustain electrode 1240 each having a single-layered structure in the same way as FIG. 4.

The scan electrode 1210 and the sustain electrode 1220 each include transparent electrodes 1210a and 1220a and bus electrodes 1210b and 1220b in FIG. 8A. Therefore, although areas of the bus electrodes 1210b and 1220b are relatively small, electrical conductivity of the scan electrode 1210 and the sustain electrode 1220 is not excessively reduced. Accordingly, an excessive reduction in the driving efficiency can be prevented, and thus an aperture ratio of the plasma display panel can be maintained at a sufficiently high level.

Because a transparent electrode is omitted in FIG. 8B, electrical conductivity of the scan electrode 1230 and the sustain electrode 1240 each having the single-layered structure must be maintained at a sufficiently high level. Therefore, areas of the scan electrode 1230 and the sustain electrode 1240 must be sufficiently wide. As a result, an aperture ratio of the plasma display panel is excessively reduced, and thus a luminance of an image displayed on the plasma display panel is excessively reduced.

Accordingly, in the structure in which the transparent electrode is omitted, a content of Xe based on the total weight of the discharge gas increases to compensate for the luminance of the image.

Xe increases the generation of vacuum ultraviolet rays during the generation of a discharge. As a content of Xe increases, the quantity of light increases. As a result, a reduction in the luminance of the image can be prevented in the structure in which the transparent electrode is omitted.

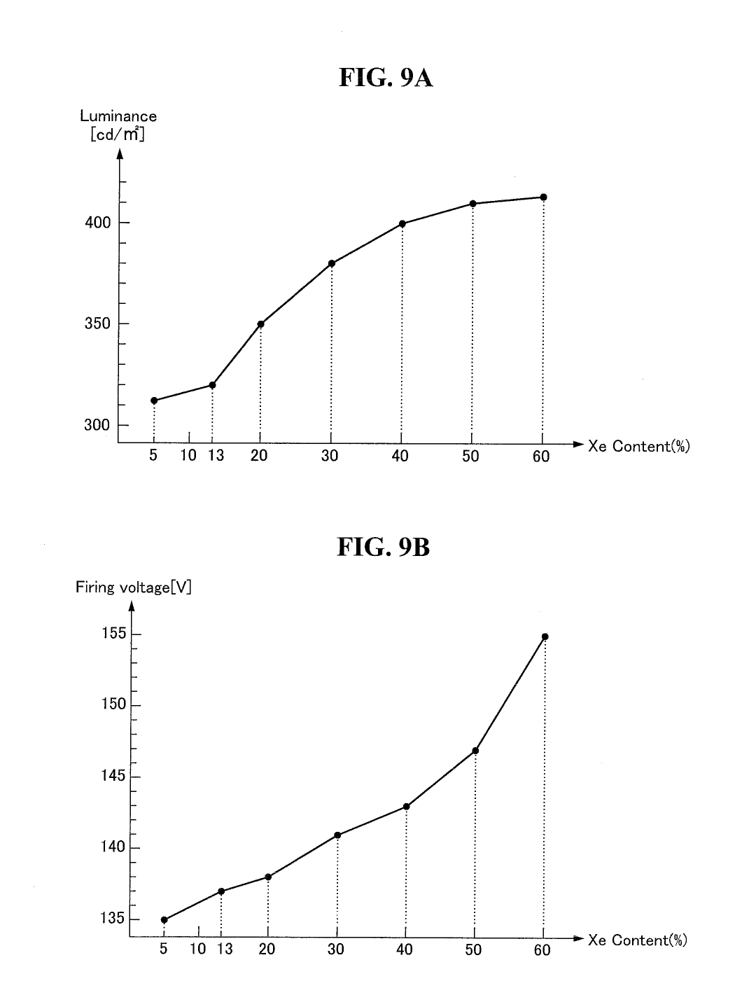

FIGS. 9A and 9B are graphs showing a luminance and a firing voltage depending on a content of Xe.

When a window pattern image of 25% is displayed on the screen on condition that a discharge gas includes Ne and Xe, a content of Ne is constant and a content of Xe changes from 5% to 60%, FIG. 9A illustrates a relationship between a luminance and a content of Xe and FIG. 9B illustrates a relationship between a firing voltage between the scan and sustain electrodes and a content of Xe. In this case, the scan and sustain electrodes each have a single-layered structure in the same way as FIG. 8B.

As illustrated in FIG. 9A, when a content of Xe is about 5%, a luminance of a displayed image is 312 cd/m² and is relatively low. When a content of Xe is about 13%, a luminance increases to 320 cd/m². Further, when a content of Xe is about 20%, 30%, 40% and 50%, a luminance is 350 cd/m², 380 cd/m², 400 cd/m² and 410 cd/m², respectively.

As can be seen from FIG. 9A, when the content of Xe is equal to or less than 50%, the luminance of the displayed image gradually increases due to an increase in the content of Xe.

On the other hand, when the content of Xe is equal to or more than 60%, a luminance is about 412 cd/m² and shows a small increase.

As illustrated in FIG. 9B, when a content of Xe is about 5%, a firing voltage between the scan and sustain electrodes is 135V. When a content of Xe is about 13%, a firing voltage is 137V. Further, when a content of Xe ranges from 20% to 50%, a firing voltage ranges from 138V to 147V. When the content of Xe is equal to or more than 60%, a firing voltage sharply increases to about 155V.

Accordingly, the discharge gas includes Xe of 10 to 50% so as to maintain a luminance of a displayed image at a sufficiently high level and to prevent an excessive rise in a firing voltage between the scan and sustain electrodes in the structure in which the transparent electrode is omitted. The discharge gas may include Xe of 13 to 30%.

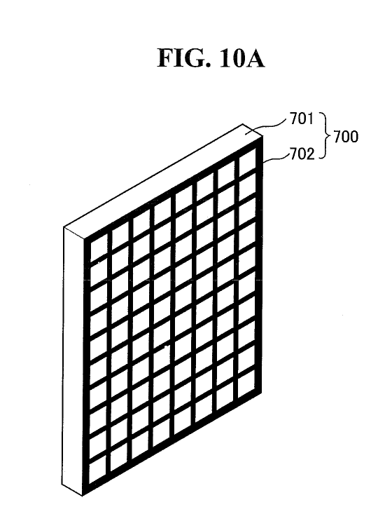

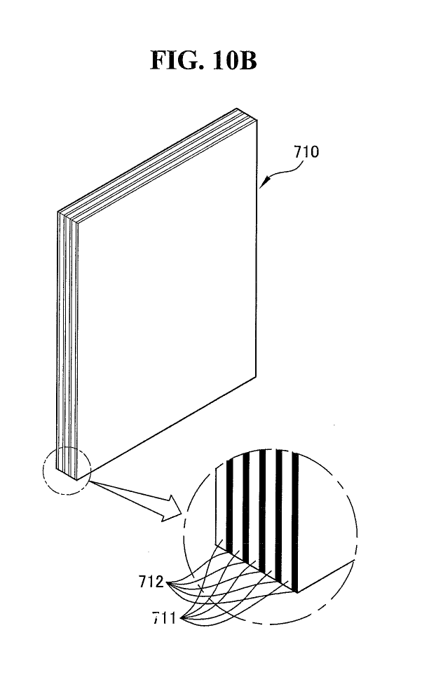

FIGS. 10A and 10B are views for explaining kinds of EMI shielding layer.

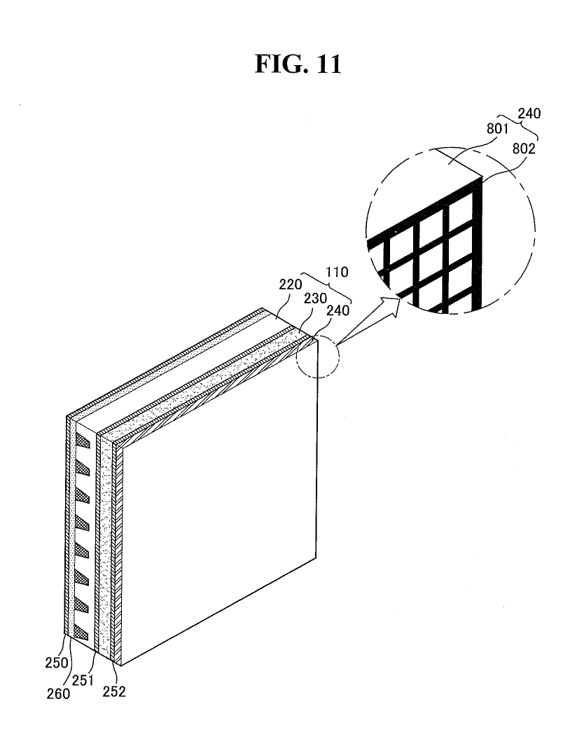

FIG. 11 illustrates an EMI shielding layer included in the filter of the plasma display apparatus according to the exemplary embodiment.

FIG. 10A illustrates a mesh type EMI shielding layer 700, and FIG. 10B illustrates a sputter type EMI shielding layer 710.

The mesh type EMI shielding layer 700 includes a base layer 701 and a mesh type metal layer 702 formed on the base layer 701.

A degree of blackness of the mesh type metal layer 702 may be larger than a degree of blackness of the base layer 701 to prevent light reflection caused by the mesh type metal layer 702. Although it is not shown, a substantially black material such as carbon (C), cobalt (Co) or ruthenium (Ru) is coated on the mesh type metal layer 702, thereby preventing light reflection caused by the mesh type metal layer 702.

The mesh type EMI shielding layer 700 may be fabricated by forming a metal layer on the base layer 701 and performing development, exposure and etching processes on the metal layer to form the mesh type metal layer 702.

Because an electrical resistance value of the base layer 701 is relatively low, EMI shielding efficiency is relatively high.

The sputter type EMI shielding layer 710 has a structure in which a plurality of transparent layers 711 and a plurality of metal layers 712 are alternately stacked in turn.

In case that the transparent layer 711 and the metal layer 712 are excessively thick, light transmittance may be excessively reduced. Therefore, the transparent layer 711 and the metal layer 712 each have a thickness equal to or less than about 1,000 Å to prevent an excessive reduction in the light transmittance.

Since the sputter type EMI shielding layer 710 has a similar structure to the near infrared ray shielding layer illustrated in FIG. 6, the sputter type EMI shielding layer 710 can perform both an EMI shielding function and a near infrared ray shielding function.

However, because the transparent layer 711 and the metal layer 712 of the sputter type EMI shielding layer 710 are relatively thin, EMI shielding efficiency of the sputter type EMI shielding layer 710 is lower than EMI shielding efficiency of the mesh type EMI shielding layer 700.

FIG. 11 illustrates the filter 110 applicable to the plasma display apparatus according to the exemplary embodiment. The filter 110 includes a mesh type EMI shielding layer.

The reason to use a mesh type EMI shielding layer 240 is that near infrared rays emitted from the plasma display panel do not have to be shielded because the control signal having the wavelength of 1 cm to 1 m is used.

In other words, since near infrared rays emitted from the plasma display panel do not have to be shielded by using the control signal having the wavelength of 1 cm to 1 m, it is advantageous to use the mesh type EMI shielding layer 240 having EMI shielding efficiency higher than EMI shielding efficiency of a sputter type EMI shielding layer.

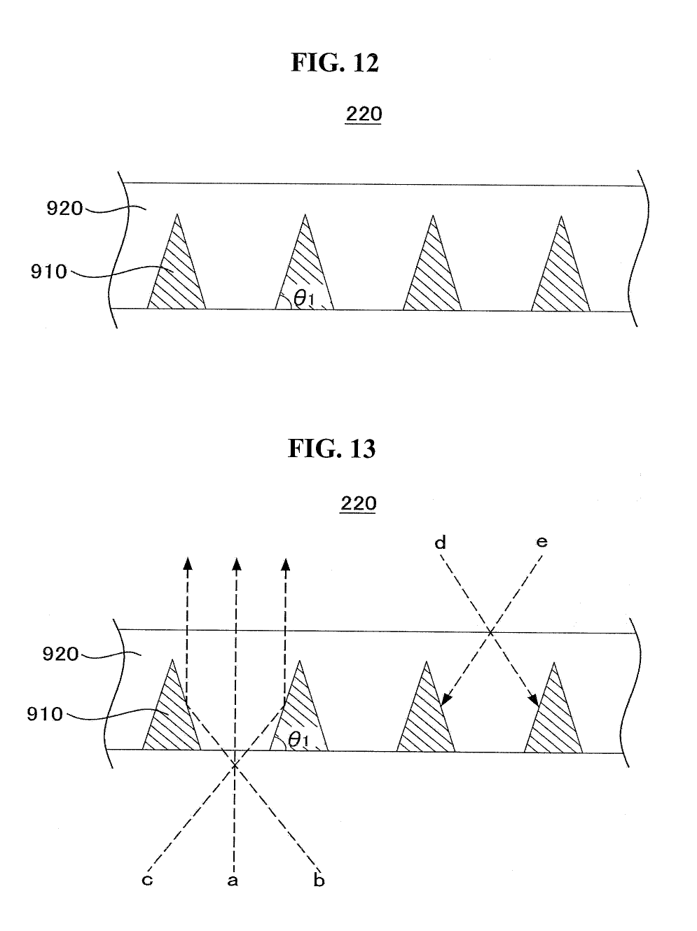

FIG. 12 illustrates the shielding layer 220 of the filter 110.

As illustrated in FIG. 12, the shielding layer 220 of the filter 110 includes a first portion 920 and a second portion 910.

The first portion 920 may be formed of a substantially transparent material. A degree of blackness of the first portion 920 is called a first blackness degree.

The second portion 910 is formed on the first portion 920 and has a second blackness degree larger than the first blackness degree. In other words, the second portion 910 is darker than the first portion 920. For instance, the second portion 910 includes carbon (C) and may be substantially black.

The second portion 910 has a gradually decreasing width as it goes toward the first portion 920. Therefore, one surface of the first portion 920 parallel to the base of the second portion 910 and the second portion 910 form a predetermined angle θ1. The angle θ1 may be equal to or more than about 702 and less than about 90°.

FIG. 13 illustrates a function of the shielding layer 220.

Referring to FIG. 13a, light generated at a point “a” positioned inside the filter (i.e., positioned inside the plasma display panel) is directly emitted to the outside. Light generated at points “b” and “c” positioned inside the filter is totally reflected by the second portion 910 and then emitted to the outside. On the other hand, light coming from points “d” and “e” positioned outside the filter (i.e., positioned outside the plasma display panel) is absorbed into the second portion 910.

When a refractive index of the second portion 910 is smaller than a refractive index of the first portion 920 and one surface of the first portion 920 parallel to the base of the second portion 910 and the second portion 910 form the predetermined angle θ1, light generated at the inside of the filter is more effectively emitted to the outside and light coming from the outside of the filter is more effectively absorbed.

As light generated at the inside of the filter is emitted to the outside and light coming from the outside of the filter is absorbed, a contrast characteristic of an image displayed on the plasma display panel is improved.

To more effectively absorb light coming from the outside of the filter and to more effectively emit light generated at the inside of the filter, a refractive index of the second portion 910 is 0.8 to 0.999 times a refractive index of the first portion 920.

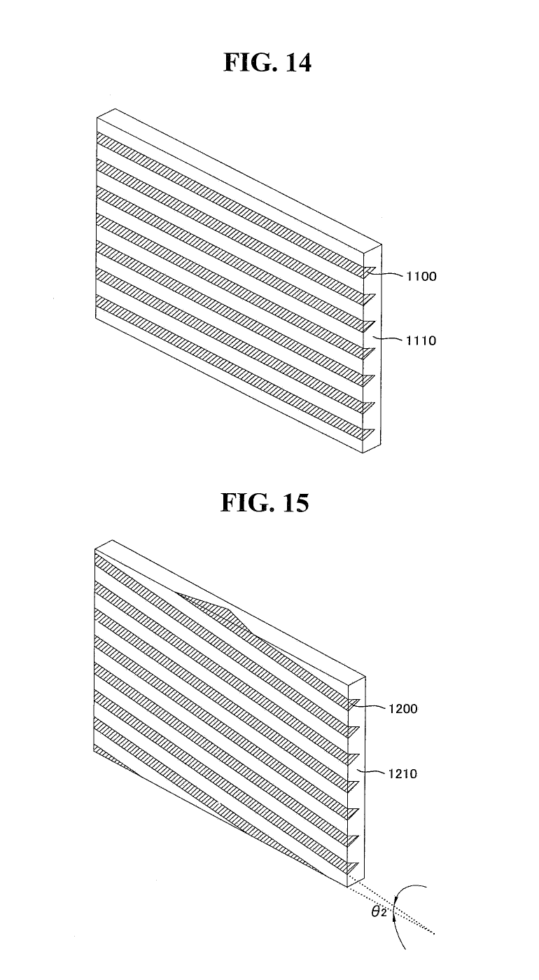

FIG. 14 illustrates an example of a traveling direction of a second portion of a filter.

FIG. 15 illustrates another example of a traveling direction of a second portion.

Referring to FIG. 14, a traveling direction of a second portion 1100 and a long side of a first portion 1110 are substantially parallel to each other.

Referring to FIG. 15, a traveling direction of a second portion 1200 intersects a long side of a first portion 1210 at a predetermined angle θ2.

As above, when the traveling direction of the second portion 1200 and the long side of the first portion 1210 form the predetermined angle θ2, an interference fringe (i.e., Moire fringe) generated when two or more periodic patterns overlap each other can be efficiently prevented.

The predetermined angle θ2 may range from about 5° to 80° to more effectively prevent Moire fringe.

As above, when the filter includes the shielding layer, the contrast characteristic is improved. However, a portion of light coming from the plasma display panel is shielded by the shielding layer, and thus a luminance of a displayed image may be reduced.

On the other hand, when a content of Xe ranges from 10% to 50% or 13% to 30% based on the total weight of the discharge gas, the generation amount of ultraviolet rays increases due to a characteristic of Xe when the plasma display panel is driven. Accordingly, the generation amount of visible light generated by the phosphor layer increases, and thus a reduction in a luminance of an displayed image can be prevented in spite of the fact that a portion of visible light is absorbed by the shielding layer.

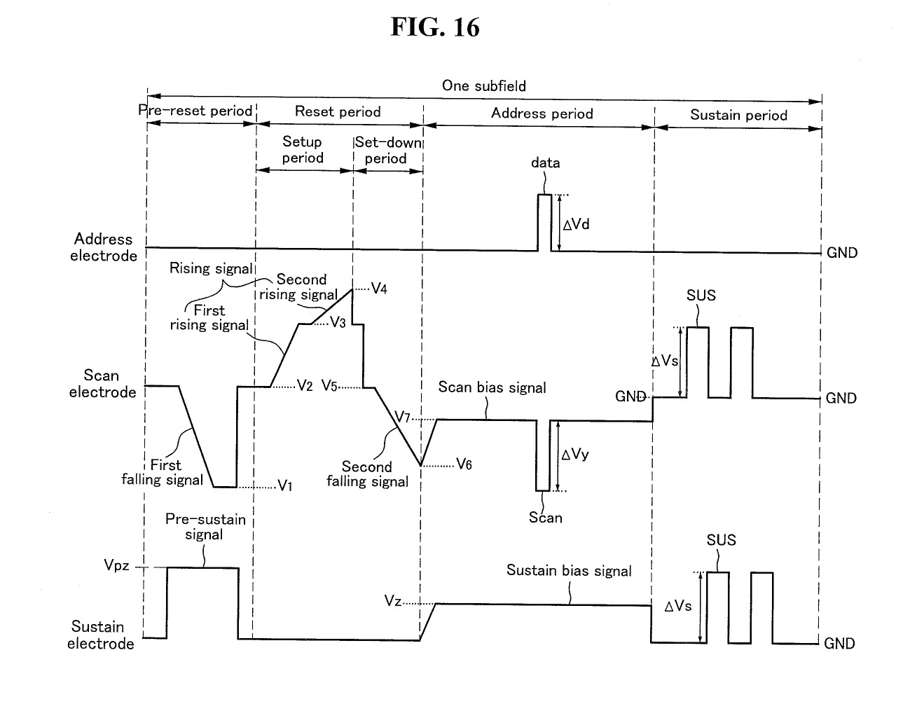

FIG. 16 illustrates an operation of the plasma display apparatus according to the exemplary embodiment.

During a pre-reset period prior to a reset period, a first falling signal is supplied to the scan electrode Y.

During the supplying of the first falling signal to the scan electrode Y, a pre-sustain signal of a polarity direction opposite a polarity direction of the first falling signal is supplied to a sustain electrode Z.

The first falling signal supplied to the scan electrode Y gradually falls to a first voltage V1.

The pre-sustain signal is substantially maintained at a pre-sustain voltage Vpz. The pre-sustain voltage Vpz is substantially equal to a voltage (i.e., a sustain voltage Vs) of a sustain signal (SUS) which will be supplied during a sustain period.

As above, during the pre-reset period, the first falling signal is supplied to the scan electrode Y and the pre-sustain signal is supplied to the sustain electrode Z, and thus wall charges of a predetermined polarity are accumulated on the scan electrode Y, and wall charges of a polarity opposite the polarity of the wall charges accumulated on the scan electrode Y are accumulated on the sustain electrode Z. For instance, wall charges of a positive polarity are accumulated on the scan electrode Y, and wall charges of a negative polarity are accumulated on the sustain electrode Z.

As a result, a setup discharge with a sufficient strength occurs during the reset period, thereby stably performing the initialization of all the discharge cells.

Furthermore, although a voltage of a rising signal supplied to the scan electrode Y during the reset period is low, a setup discharge with a sufficient strength occurs.

A subfield, which is first arranged in time order in a plurality of subfields of one frame, may include a pre-reset period prior to a reset period so as to obtain sufficient driving time. Or, two or three subfields of the plurality of subfields may include a pre-reset period prior to a reset period.

All the subfields may not include the pre-reset period.

During the reset period, a reset signal is supplied to the scan electrode Y. The reset signal includes a rising signal and a falling signal. The reset period is further divided into a setup period and a set-down period.

During the setup period, a rising signal including a first rising signal and a second rising signal is supplied to the scan electrode Y. The first rising signal gradually rises from a second voltage V2 to a third voltage V3 with a first slope, and the second rising signal gradually rises from the third voltage V3 to a fourth voltage V4 with a second slope.

The rising signal generates a weak dark discharge (i.e., a setup discharge) inside the discharge cell during the setup period, thereby accumulating a proper amount of wall charges inside the discharge cell.

During the set-down period, a second falling signal of a polarity direction opposite a polarity direction of the rising signal is supplied to the scan electrode Y.

The second falling signal gradually falls from a fifth voltage V5 lower than a peak voltage (i.e., the fourth voltage V4) of the rising signal to a sixth voltage V6.

The second falling signal generates a weak erase discharge (i.e., a set-down discharge) inside the discharge cell. Furthermore, the remaining wall charges are uniform inside the discharge cells to the extent that an address discharge can be stably performed.

During an address period, a scan bias signal, which is maintained at a seventh voltage V7 higher than a lowest voltage (i.e., the sixth voltage V6) of the second falling signal, is supplied to the scan electrode Y.

A scan signal (Scan), which falls from the scan bias signal by a scan voltage magnitude ΔVy, is supplied to the scan electrode Y.

A width of a scan signal supplied during an address period of at least one subfield may be different from a width of a scan signal supplied during address periods of the other subfields. For instance, a width of a scan signal in a subfield may be larger than a width of a scan signal in the next subfield in time order. Further, a width of the scan signal may be gradually reduced in the order of 2.6 μs, 2.3 μs, 2.1 μs, 1.9 μs, etc., or in the order of 2.6 μs, 2.3 μs, 2.3 μs, 2.1 μs, 1.9 μs, 1.9 μs, etc.

As above, when the scan signal (Scan) is supplied to the scan electrode Y, a data signal (data) corresponding to the scan signal (Scan) is supplied to the address electrode X. The data signal (data) rises from a ground level voltage GND by a data voltage magnitude ΔVd.

As the voltage difference between the scan signal (Scan) and the data signal (data) is added to the wall voltage generated during the reset period, the address discharge occurs within the discharge cell to which the data signal (data) is supplied.

A sustain bias signal is supplied to the sustain electrode Z during the address period to prevent the generation of the unstable address discharge by interference of the sustain electrode Z.

The sustain bias signal is substantially maintained at a sustain bias voltage Vz. The sustain bias voltage Vz is lower than the voltage Vs of the sustain signal and is higher than the ground level voltage GND.

During the sustain period, a sustain signal (SUS) is alternately supplied to the scan electrode Y and the sustain electrode Z. The sustain signal (SUS) has a voltage magnitude corresponding to the sustain voltage Vs.

As the wall voltage within the discharge cell selected by performing the address discharge is added to the sustain voltage Vs of the sustain signal (SUS), every time the sustain signal (SUS) is supplied, the sustain discharge, i.e., a display discharge occurs between the scan electrode Y and the sustain electrode Z. Accordingly, a predetermined image is displayed on the plasma display panel.

A plurality of sustain signals are supplied during a sustain period of at least one subfield, and a width of at least one of the plurality of sustain signals may be different from widths of the other sustain signals. For instance, a width of a first supplied sustain signal among the plurality of sustain signals may be larger than widths of the other sustain signals. Hence, a sustain discharge can be more stable.

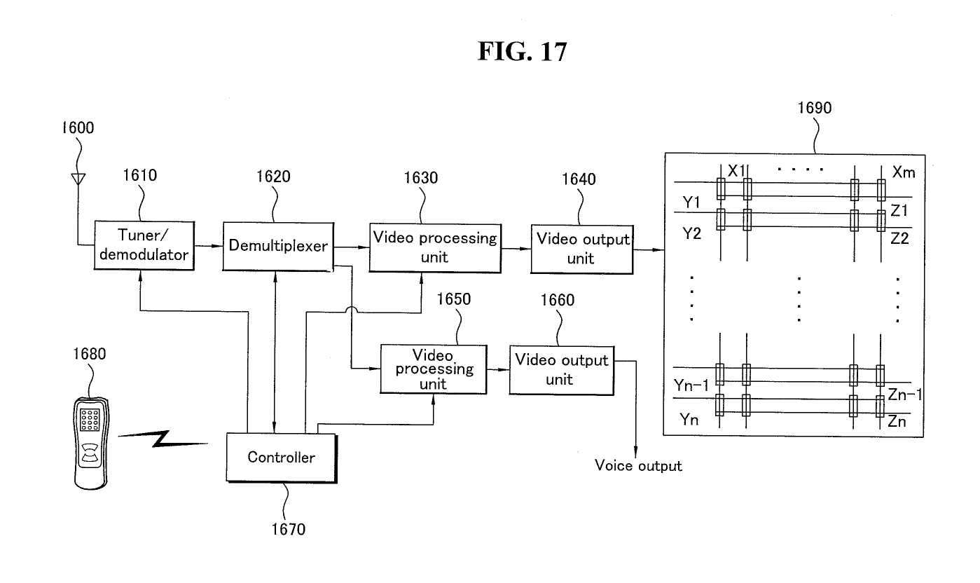

FIG. 17 illustrates a television set including the plasma display apparatus according to the exemplary embodiment.

As illustrated in FIG. 17, a television set including the plasma display apparatus according to the exemplary embodiment includes an antenna unit 1600, a tuner/demodulator 1610, a demultiplexer 1620, a video processing unit 1630, a video output unit 1640, a voice processing unit 1650, a voice output unit 1660, a controller 1670, and a video display unit 1690. Further, the television set may further include a remote controller 1680.

The video display unit 1690 is a plasma display panel including electrodes. Although it is not shown, a filter is positioned in front of the plasma display panel 1690, and a near infrared ray shielding layer may be omitted from the filter.

The tuner/demodulator 1610 receives a broadcasting signal through the antenna unit 1600, and selects the broadcasting signal depending on a channel selected by a user.

The demultiplexer 1620 divides the broadcasting signal depending on an attribute of the broadcasting signal selected through the tuner/demodulator 1610. For instance, the broadcasting signal is divided into a video signal and a voice signal.

The video processing unit 1630 performs video processing on the broadcasting signal to allow predetermined video information divided by the demultiplexer 1620 to be displayed on the screen.

The video output unit 1640 converts the video information processed by the video processing unit 1630 into a driving signal, and supplies the driving signal to the plasma display panel 1690.

The plasma display panel 1690 displays a predetermined video on the screen in response to the driving signal received from the video output unit 1640.

The voice processing unit 1650 performs voice processing on predetermined voice information divided by the demultiplexer 1620 so that the user can listen to the voice information.

The voice output unit 1660 outputs the voice signal processed by the voice processing unit 1650.

The controller 1670 controls the video signal output and the voice signal output in response to an input control signal. The controller 1670 receives a control signal having a wavelength of 1 cm of 1 m and controls the video signal.

When the antenna unit 1600 receives the broadcasting signal, the tuner/demodulator 1610 receives the broadcasting signal through the antenna unit 1600 and selects the broadcasting signal of a channel selected by the user depending on the control signal of the controller 1670.

For instance, the user sends a control signal for channel selection to the controller 1670 in a radio communication manner using the remote controller 1680. The control signal for channel selection is a control signal having a wavelength of 1 cm of 1 m. The controller 1670 receives the control signal for channel selection and controls the video signal using the control signal.

Since the controller 1670 controls the video signal using the control signal having a wavelength of 1 cm of 1 m, a malfunction of another device such as the remote controller 1680 can be prevented although the near infrared shielding layer is omitted from the filter.

The demultiplexer 1620 divides the broadcasting signal depending on an attribute of the broadcasting signal selected through the tuner/demodulator 1610. The video processing unit 1630 and the voice processing unit 1650 receive video information, voice information and additional information divided by the demultiplexer 1620.

The video processing unit 1630 performs video processing on the broadcasting signal so that the user can watch the video information. The video information is supplied to the plasma display panel 1690 through the video output unit 1640. Hence, an image is displayed on the screen of the plasma display panel 1690.

The voice processing unit 1650 performs voice processing on the voice information so that the user can listen the voice information through the voice output unit 1660.

As above, since the control signal having the wavelength of 1 cm to 1 m is used in the television set, the near infrared shielding layer may be omitted from the filter positioned in front of the plasma display panel 1690. Accordingly, the fabrication cost of the television set can be reduced.

The foregoing embodiments and advantages are merely exemplary and are not to be construed as limiting the present invention. The present teaching can be readily applied to other types of apparatuses. The description of the foregoing embodiments is intended to be illustrative, and not to limit the scope of the claims. Many alternatives, modifications, and variations will be apparent to those skilled in the art.

What is claimed is:

1. A plasma display apparatus comprising:
a plasma display panel that displays an image using a control signal having a wavelength of 1 cm to 1 m received from the outside; and
a filter that is positioned in front of the plasma display panel, a near infrared ray shielding layer being omitted from the filter.

2. The plasma display apparatus of claim 1, wherein the control signal includes a bluetooth signal or a radio frequency (RF) signal.

3. The plasma display apparatus of claim 1, wherein the plasma display panel includes a scan electrode and a sustain electrode positioned parallel to each other, and
at least one of the scan electrode or the sustain electrode is a bus electrode.

4. The plasma display apparatus of claim 3, wherein a discharge gas is filled inside the plasma display panel, and includes xenon (Xe) of 10% to 50%.

5. The plasma display apparatus of claim 3, wherein the discharge gas includes xenon (Xe) of 13% to 30%.

6. The plasma display apparatus of claim 1, wherein the control signal having a wavelength of 0.11 m to 0.13 m.

7. A plasma display apparatus comprising:
a plasma display panel;
a filter that is positioned in front of the plasma display panel and includes a mesh type electromagnetic interference (EMI) shielding layer, a near infrared ray shielding layer being omitted from the filter; and
a driver that drives the plasma display panel using a control signal having a wavelength of 1 cm to 1 m received from the outside.

8. The plasma display apparatus of claim 7, wherein the control signal includes a bluetooth signal or an RF signal.

9. The plasma display apparatus of claim 7, wherein the plasma display panel includes a scan electrode and a sustain electrode positioned parallel to each other, and
at least one of the scan electrode or the sustain electrode is a bus electrode.

10. The plasma display apparatus of claim 9, wherein a discharge gas is filled inside the plasma display panel, and includes xenon (Xe) of 10% to 50%.

11. The plasma display apparatus of claim 10, wherein the discharge gas includes xenon (Xe) of 13% to 30%.

12. The plasma display apparatus of claim 7, wherein wherein the control signal having a wavelength of 0.11 m to 0.13 m.

13. A television set comprising:
a demultiplexer that divides an input signal into a video signal and a voice signal;
a video processing unit that processes the video signal to allow a user to watch the video signal;
a plasma display panel that displays the video signal processed by the video processing unit;
a filter that is positioned in front of the plasma display panel, a near infrared ray shielding layer being omitted from the filter; and
a controller that receives a control signal having a wavelength of 1 cm to 1 m and controls the video signal using the control signal.

14. The television set of claim 13, wherein the control signal includes a bluetooth signal or a RF signal.

15. The television set of claim 13, wherein the filter includes a mesh type electromagnetic interference (EMI) shielding layer.

16. The television set of claim 13, wherein the plasma display panel includes a scan electrode and a sustain electrode positioned parallel to each other, and
at least one of the scan electrode or the sustain electrode is a bus electrode.

17. The television set of claim 16, wherein a discharge gas is filled inside the plasma display panel, and includes xenon (Xe) of 10% to 50%.

18. The television set of claim 17, wherein the discharge gas includes xenon (Xe) of 13% to 30%.

19. The television set of claim 13, wherein the control signal having a wavelength of 0.11 m to 0.13 m.
